(19) United States
(12) Patent Application Publication
(10) Pub. No.: US 2012/0203798 A1
(43) Pub. Date: Aug. 9, 2012

(54) SECURE MEDICAL RECORD INFORMATION SYSTEM

(76) Inventors: Lori Gifford, Parker, CO (US); Tracey Gifford, Parker, CO (US)

(21) Appl. No.: 13/369,064

(22) Filed: Feb. 8, 2012

Related U.S. Application Data
(60) Provisional application No. 61/441,075, filed on Feb. 9, 2011.

(51) Int. Cl. G06F 17/30

(52) U.S. Cl. 707/783; 707/E17.044

(57) ABSTRACT

A medical records system allows a patient to have control and responsibility over their medical records. The system includes a patient-centric records server that functions as a central repository for patients' medical records. The patient can access and review their medical records. Further, to control access to some or all of the medical records, the patient also can hide one or more files within their medical records. As such, if a doctor accesses the medical records, the doctor only sees what the patient leaves unhidden. Thus, the system provides a means for the patient to control sensitive information within their medical records.

### REFERENCE TO RELATED APPLICATIONS

This application claims priority to U.S. Provisional Application 61/441075, filed Feb. 9, 2011, entitled “SECURE MEDICAL RECORD INFORMATION SYSTEM,” which is incorporated by reference herein for all that it teaches and for all purposes.

### BACKGROUND

National health care reform is requiring significant changes to how medical records are managed. Included in the changes is a mandate for all medical organizations to use an electronic medical records (EMR) system. Further, medical organizations must share their electronic records with other health care organizations by depositing the records in a central database. Access to the database allows other physicians or health care professionals view and study a patient's medical history before or in conjunction with their treatment.

Unfortunately, the security of the information has not been an important consideration. Doctors or other medical organization may be able to gain unfettered access to the patient records without the knowledge or consent of the patient. Thus, if a patient has sensitive information within their medical records, the sensitive information is available for public consumption. Patients have little power or ability to manage access to their medical records.

### SUMMARY

It is with respect to the above issues and other problems that the embodiments presented herein were contemplated. Embodiments described in the present application provide systems and methods for allowing a patient to have control and responsibility over their medical records. The system includes a patient-centric records server that functions as a central repository for patients' medical records. The patient can access and review their medical records. Further, to control access to some or all of the medical records, the patient also can hide one or more files within their medical records. As such, if a doctor accesses the medical records, the doctor only sees what the patient leaves unhidden. Thus, the system provides a means for the patient to control sensitive information within their medical records.

The term “network” as used herein refers to a system used by a communication platform to provide communications between communication endpoints. The network can consist of one or more session managers, feature servers, communication endpoints, etc. that allow communications, whether voice or data, between two users. A network can be any network or communication system as described in conjunction with FIGS. 6 and 7. Generally, a network can be a local area network (LAN), a wide area network (WAN), a wireless LAN, a wireless WAN, the Internet, etc. that receives and transmits messages or data between devices to facilitate communication platform activities. A network may communicate in any format or protocol known in the art, such as, transmission control protocol/internet protocol (TCP/IP), 802.11g, 802.11n, Bluetooth, or other formats or protocols.

The term “virtual private network (VPN),” as used herein, can mean a computer network that uses a public telecommunication infrastructure, such as the Internet, to provide users with secure access to an organization's network. The VPN aims to avoid an expensive system of owned or leased lines that can be used by only one organization. A VPN can encapsulate data transfers using a secure cryptographic method between two or more networked devices, which are not on the same private network, so as to keep the transferred data private from other devices on one or more intervening local or wide area networks.

The term “database” or “data structure” as used herein refers to any system, hardware, software, memory, storage device, firmware, component, etc., that stores data. The data model can be any type of database or storage framework described in conjunction with FIGS. 6 and 7, which is stored on any type of non-transitory, tangible computer readable medium. A database can include one or more data structures, which may comprise one or more sections or portions that store an item of data. A section may include, depending on the type of data structure, an attribute of an object, a data field, or other types of sections included in one or more types of data structures. The data structure can represent a text string or be a component of any type of database, for example, relational databases, flat file databases, object-oriented databases, or other types of databases. Further, the data structures can be stored in memory or memory structures that may be used in either run-time applications or in initializing a communication.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “in communication with” as used herein refers to any coupling, connection, or interaction using electrical signals to exchange information or data, using any system, hardware, software, protocol, or format.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” or “computer program product” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the embodiments are considered to include a tangible storage medium and prior art-recognized equivalents and successor media, in which the software implementations of the present embodiments are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the description includes exemplary embodiments, different aspects of the embodiments can be separately claimed.

### BRIEF DESCRIPTION OF THE DRAWINGS

The present disclosure is described in conjunction with the appended figures:

FIG. 1 is a block diagram of an embodiment of a system for securely managing patient medical records;

FIG. 2A is a block diagram of an embodiment of a patient-centric record server;

FIG. 2B is a block diagram of an embodiment of a doctor, medical organization, and/or entity system for interfacing with the patient-centric record server;

FIGS. 3A and 3B are embodiments of data structures operable to store securely patient records;

FIGS. 4A-4E are embodiments of user interface display operable to be presented to help manage patient records;

FIGS. 5A and 5 B are flow diagrams of embodiments of a process for managing patient records;

FIGS. 6A and 6 B are flow diagrams of embodiments of a process for securely managing patient records when in communication with a medical organization;

FIG. 7 is a flow diagram of an embodiment of a process for creating and providing a digital prescription to a user;

FIG. 8 is a block diagram of an embodiment of a computing environment operable to execute the embodiments described herein;

FIG. 9 is a block diagram of an embodiment of a computer or computing system environment operable to execute as the one or more devices described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

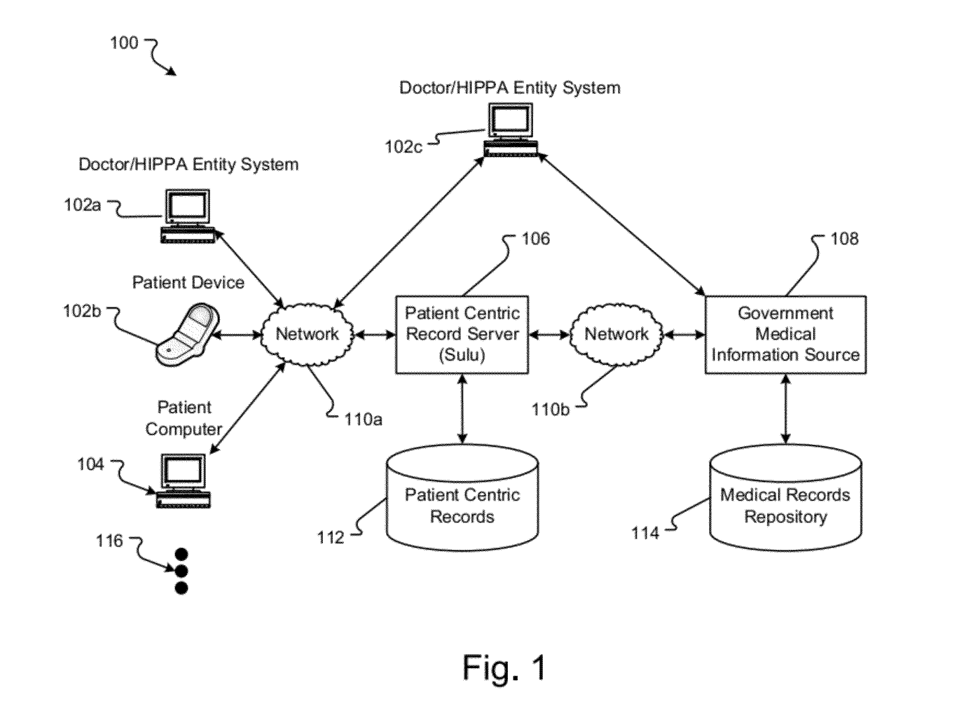

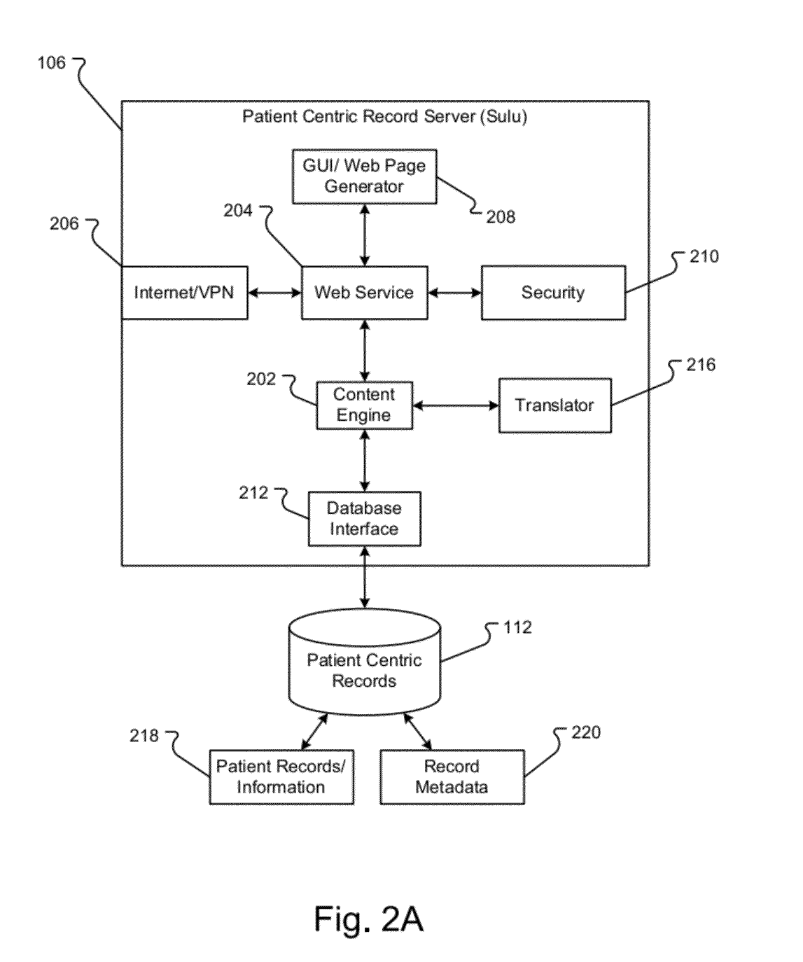

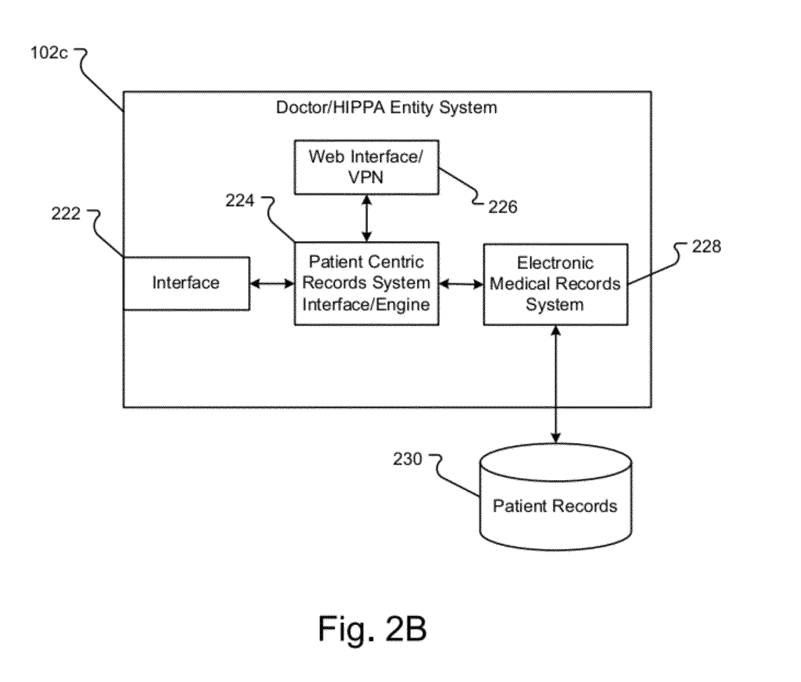

A patient-centric medical record information system 100 is shown in FIG. 1. The system 100 can consist of one or more components which can include hardware and/or software operable to execute the functions as described herein. In embodiments, the system 100 includes a patient-centric record server 106. Patient-centric record server 106 can be any hardware and/or software operable to communicate with patients and other information sources to provide or to receive medical record information. Thus, the patient-centric record server 106 can be in communication with one or more information sources 102 or 108, one or more patients' computers 104, and/or medical records databases 112. An embodiment of a patient-centric record server 106 is as described in conjunction with FIG. 2A.

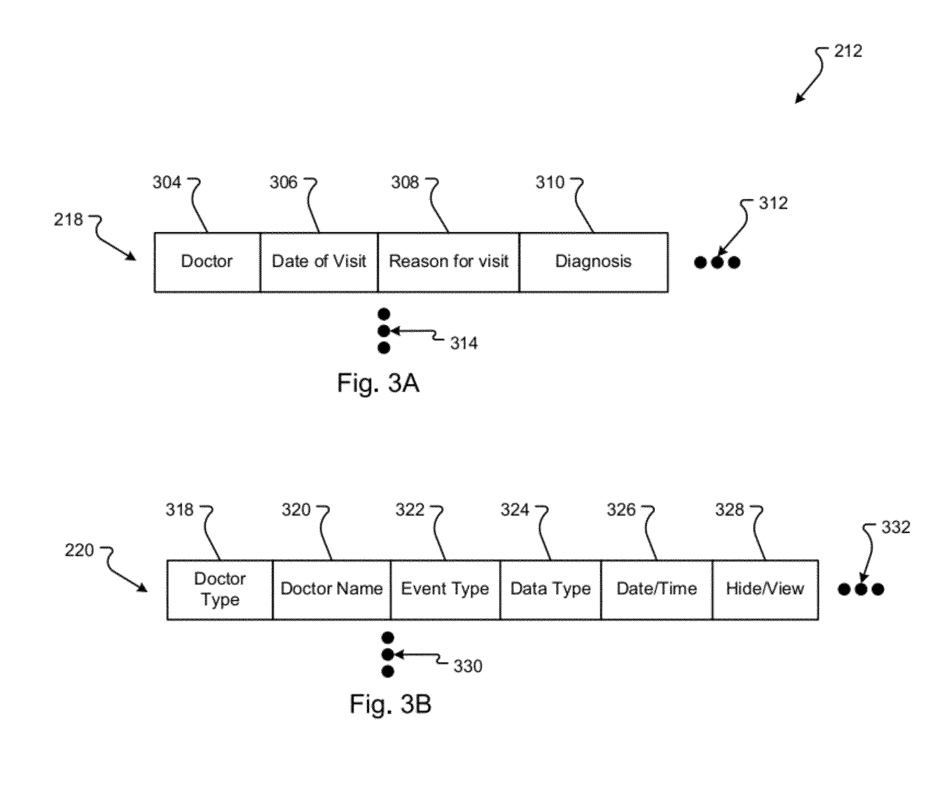

Information systems 102 can include doctors or other medical organizations that administer medical information. The medical information may be managed with a doctor or HIPPA entity system 102a that may include an electronic medical records (EMR) system. The doctor system 102a may be operable to store medical information in an electronic or digital format for communication over electronic communication channels. Thus, the doctor system 102a can communicate and/or receive medical information. The medical information can be displayed to personnel at the medical organization. An embodiment of an doctor system 102a is as explained in conjunction with FIG. 3.

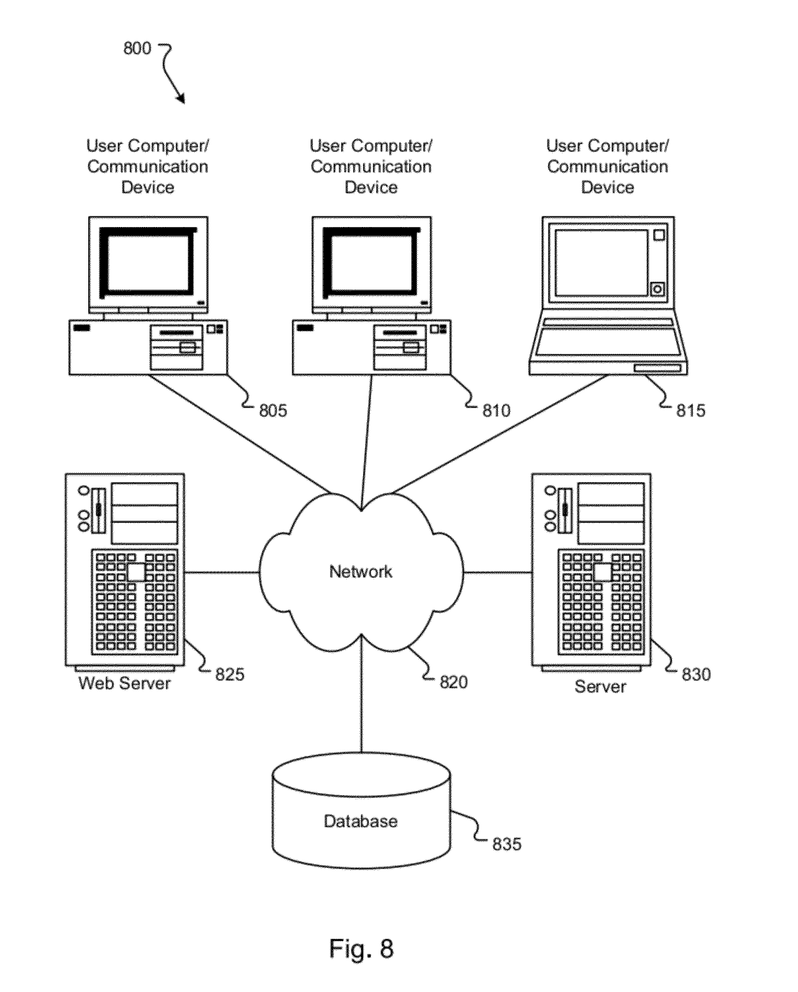

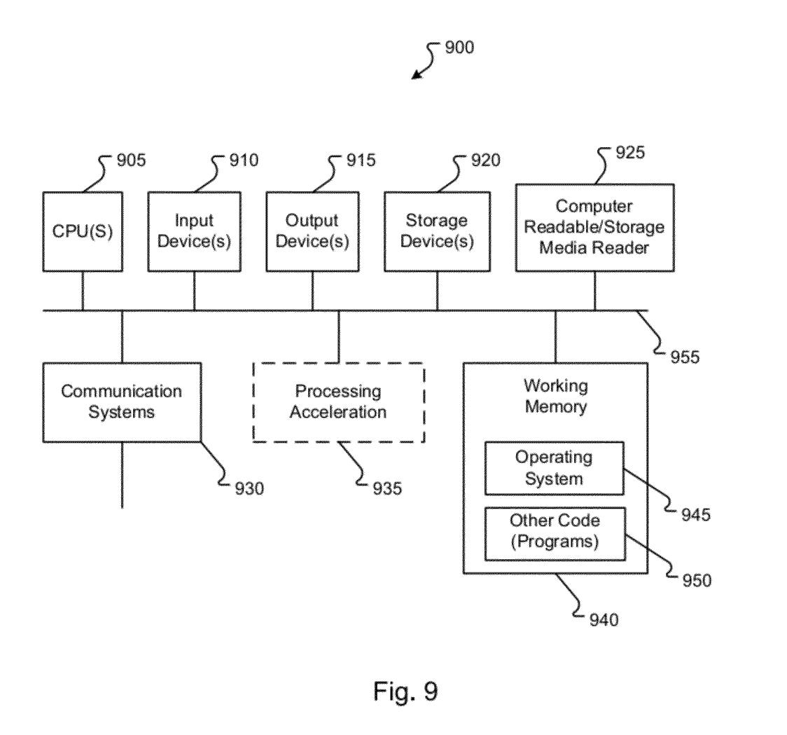

The user computer 108 can be any computing device as described in conjunction with FIGS. 8 and 9. The user computer 108 may be operable to communicate with the patient-centric record server 106 to exchange medical information and/or manage medical records contained in the patient-centric records database 112. Thus, the user computer 108 is operable to provide displays of medical information and receive or send data regarding medical records associated with the patient.

In embodiments, the user computer 108 can communicate with a user device 102b. The user device 102b can be a device operable to store information to communicate with the doctor system 102a. The devices 102b can include universal serial bus (USB) drives, mobile devices (e.g., mobile telephones, personal digital assistants (PDAs), etc.), or other storage devices (e.g., memory cards). The device 102b can store information for security purposes to insure secure communications between doctor system 102a and the patient-centric record server 106.

The patient-centric records database 112 can include any database or database system as described in conjunction with FIGS. 8 and 9. The information stored within the patient-centric records database 112 can be as described in conjuncture with FIGS. 3A and 3B. The patient-centric records database 112 can be operable to store, retrieve, receive, and provide medical record information to the patient-centric record server 106.

In embodiments, the patient-centric record server 106 can communicate with one or more government information sources 108. The government information sources 108 can include other systems, whether hardware and/or software, which also store medical information. These systems may be required by state or federal law wherein these systems store medical records for transport to or view by medical organizations. Thus, the government information sources 108 can communicate with other medical organizations EMR systems 102C to provide or receive information from those systems 102c. The government information sources 108 may include a medical records repository 114 similar to an EMR system, but, in embodiments, the patient-centric record server 106 can interact with the government information sources 108 to obtain records information from the medical records repository 114.

An embodiment of a patient-centric record server 106 is shown in FIG. 2A. The patient-centric record server 106 can include one or more components which may be hardware and/or software that are operable to execute the functions described herein. Hereinafter, the components will be described as software objects or modules that execute on a processor causing the processor to conduct certain functions. However, the embodiments are not so limited. In embodiments, the patient-centric record server 106 can include one or more, but is not limited to, the following modules: a graphical user interface (GUI)/web page generator 208, a web service module 204, a security module 210, an internet/virtual private network (VPN) module 206, a content engine 202, a translator module 216, and/or a database interface 212.

The patient-centric record server 106 can include an Internet interface 206, which can communicate over one or more networks 110, including the Internet, to exchange information between the patient-centric record server 106 and the user computer 104 or other entity or system. The Internet interface 206 can communicate through one or more communication protocols including, but not limited to, hypertext transfer protocol (HTTP), real-time transport protocol (RTP), or other protocols as described in one or more technical documents provided by the Internet Engineering Task Force (IETF), which are incorporated by reference herein in their entirety for all that the documents teach. In embodiments, the internet interface 206 can establish a VPN with a patient computer 104. The VPN 206 allows for the exchange of data securely between the patient computer 104 and the patient-centric record server 106. The establishment and creation of a VPN is well known in the art and shall not be explained herein.

The web service 204 is operable to create one or more web pages for the Internet interface 206 to be transferred to the patient computer 104. The web service 204 can provide the HTML to generate displays on the user's computer 104 to provide the functionality to allow the patient to manage their medical records on the patient-centric record server 106. The web service 204 is operable to interface with other modules to receive information or other data in order to communicate that information to the patient.

The GUI/web page generator 208 is operable to generate the layout and graphics of one or more web pages to provide to the web service 204. The web page generator 208 can create HTML code that may be communicated to the patient computer 102. When creating a web page, the web page generator 208 can receive data from the web service 204 or one or more other modules to provide information inside of a graphical user interface that will be provided to the patient computer 104 as a web page.

A content engine 202 can store and retrieve medical records information to be provided to the web page generator 208 and/or the web service 204. The content engine 202 is operable to determine or translate requests from the web service 204 related to data received from the patient or data requested by the patient. The content engine 202 can also interface with a database interface 212 to retrieve or store medical record and other information. Thus, the content engine 202 is operable to conduct retrievals of or store data through the database interface 212 to the patient-centric records database 112.

The database interface 212 is an application programming interface (API) or other interface to with the patient-centric records database 112 used to store the patient medical records. The database interface 212 is operable to translate requests from the content engine 202 into a protocol that is understood by the patient-centric records database 112. The patient-centric records database 112 can store information about the patient records. In embodiments, the patient-centric records database 112 can store at least two types of data, which can include the actual medical information 218 and the metadata 220 associated with the patient records. Both the patient records 218 and record metadata 220 are described in conjunction with FIGS. 3A and 3B.

A translator 216 may be operable to translate information received from one or more sources to be provided to the content engine 202. For example, data received through a government source 108 that includes a proprietary medical records depository 114 may be in a format different from what is stored in the patient-centric records database 112. As such, the translator 216 can translate the information into a format that can be used by. The translation may include reorganizing fields within the data or changing the data into a protocol or format that is understood by the patient-centric records database 112.

The patient-centric record server 106 can also include a security module 210. The security module 210 can determine if the patient or system communicating with the patient-centric record server 106 is authorized to access files or complete one or more other functions with the patient-centric record server 106. In embodiments, the security module 210 can check identification of the entity either through a comparison of digital data or by the reception of a user name and password. In other embodiments, the security module 210 can also provide encoding or encrypting of messages to ensure the secure transmission of those messages to the patient computer 104 or other system 102.

A medical organization or Health Insurance Portability and Accountability Act (HIPAA) entity system is shown in FIG. 2B. The HIPAA entity system 102b can include one or more modules that may be hardware and/or software. These modules can include a web interface/VPN 226, an interface module 222, a patient-centric record system interface/engine 224, an electronic medical records system 228, and a patient records database 230.

The web interface/VPN 226 can be the same or similar to the Internet interface/VPN 206, as described in FIG. 2A. As such, the web interface/VPN 226 shall not be explained further herein. The interface 222 can be any interface to one or more patient devices 102b. Therefore, the interface 222 can be a Bluetooth or other wireless interface, such as 802.11G, or other communication devices. The interface 222 can also be a USB interface that interfaces with a memory device that is inserted into a mechanical coupling to communicate with the interface 222. The interface 222 is operable to communicate with the patient device 102b through any protocol or system used to exchange data between the patient device 102b.

A patient-centric record system interface/engine 224 is operable to receive information from the EMR system 228 and provide that information through a web interface 226 to the patient-centric record server 106. Further, the patient-centric record system interface/engine 224 can request patient records from the patient-centric record server 106 through the web interface 226. Thus, the patient-centric record system interface/engine 224 can obtain information, from the patient and through the interface 222, and send that information to the patient-centric record server 106 to be authorized to receive medical records associated with the patient. Upon authorization, the medical records may be sent back to the patient-centric record system interface/engine 224 to be displaced on a user interface device for the doctor or other medical professional. Further these files may be stored in EMR system 228 if pertinent to the treatment or care of the patient, authorized by the patient, and requested by the doctor. Thus, the patient-centric record system interface/engine 224 can obtain copies of the medical records to be transferred to the EMR system 228.

The EMR system 228 can be any electronic medical record system as known in the art. This EMR system 228 is operable to communicate with the patient records database 232 to store, retrieve, and/or manage patient records. The EMR system 228 can communicate with the patient-centric record system interface/engine 224 to obtain or provide medical records from the patient-centric record server 106.

An embodiment of a patient record 218 is shown in FIG. 3A, and an embodiment of metadata 220, associated with the patient record, is shown in FIG. 3B. The patient record 218 and/or metadata 220 can include one or more portions stored in a data structure or other type of data storage system or module. The patient record 218 and/or metadata 220 may include more or fewer portions than those shown in FIGS. 3A or 3B, as represented by ellipses 312 and/or 332. A single patient record 218 and/or metadata 220 is shown in FIGS. 3A or 3B, but there may be more patient records or metadata, used by the patient-centric record server 106 shown in FIG. 1, as represented by ellipses 314 and/or 330. Embodiments of the patient record 218 and/or metadata 220 can include portions for storing data associated with medical care or treatment of a patient.

The patient record 218 can include information from one or more visits to a doctor or medial care professional. Some of the data stored and associated with the visit(s) can include, but is not limited to, a doctor name 304, a date of a visit 306, a reason for the visit 308, and a diagnosis 310. The doctor name 304 can be the name of the primary physician, registered nurse practitioner, or other medical professional conducting the care of the patient. The date of the visits 306 can include one or more dates when the patient was seen by the doctor. The reason for the visit 308 can be any ailment or other compliant by the patient presented to the doctor. The diagnosis 310 can include what the doctor perceived as the problem at the time of the visit. The diagnosis 310 can also include any kind of treatment plan presented to the patient. Thus, the diagnosis 310 can include prescriptions or other care information provided to the patient or recorded by the doctor.

The metadata 220 may be provided and be selectable to be presented within a patient record 218, or may be metadata not displayed but associated with the patient records 218. The information within the metadata 220 may be sorted or may be filtered to allow the user to select two or more files that may then be managed, such as selecting a hide value in field 328 for two or more files. The metadata 220 can include one or more of, but is not limited to, a doctor type 318, a doctor name 320, an event type 322, a data type 324, a date and time 326, and a hide view field 328. A doctor type 318 can be what type of medical professional saw the patient. The possible doctor types 318 can include an emergency physician, a general practice professional, a registered nurse practitioner, an urgent care facility, or other type of medical professional. The doctor name can be the field in which doctor name 304 is presented. The event type 322 can be the type of event that created or caused the person to see medical care. The event type 322 can include such information as whether the visit was to an urgent care facility, an emergency care facility, the result of an emergency call to 911, a medical examination by a person's general care physician, or other types of events. The data type 324 can be what type of data is associated with the patient record 218. The data type 324 can include information such as whether the patient received a prescription, a diagnosis from a doctor, a report from an emergency facility, or other types of data. The date/time field 326 provides a field for the date of the visit 306. The hide view field 328 is a patient selectable field that allows the patient to hide the patient record 218 associated with the metadata 220. Thus, if the patient believes the information should be private, the patient can select to hide the patient record 218 by entering a value within the hide field 328. Methods for entering the value into the hide field 328 will be discussed hereinafter. variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware modules or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other types of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When

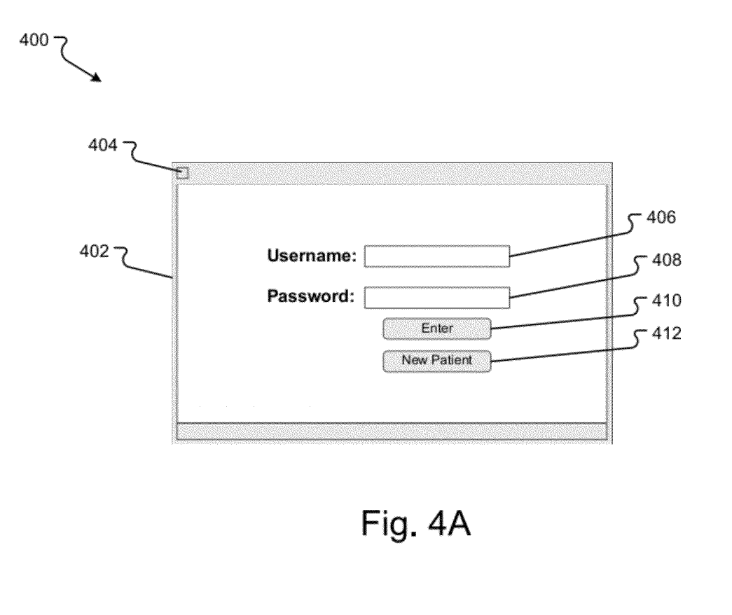

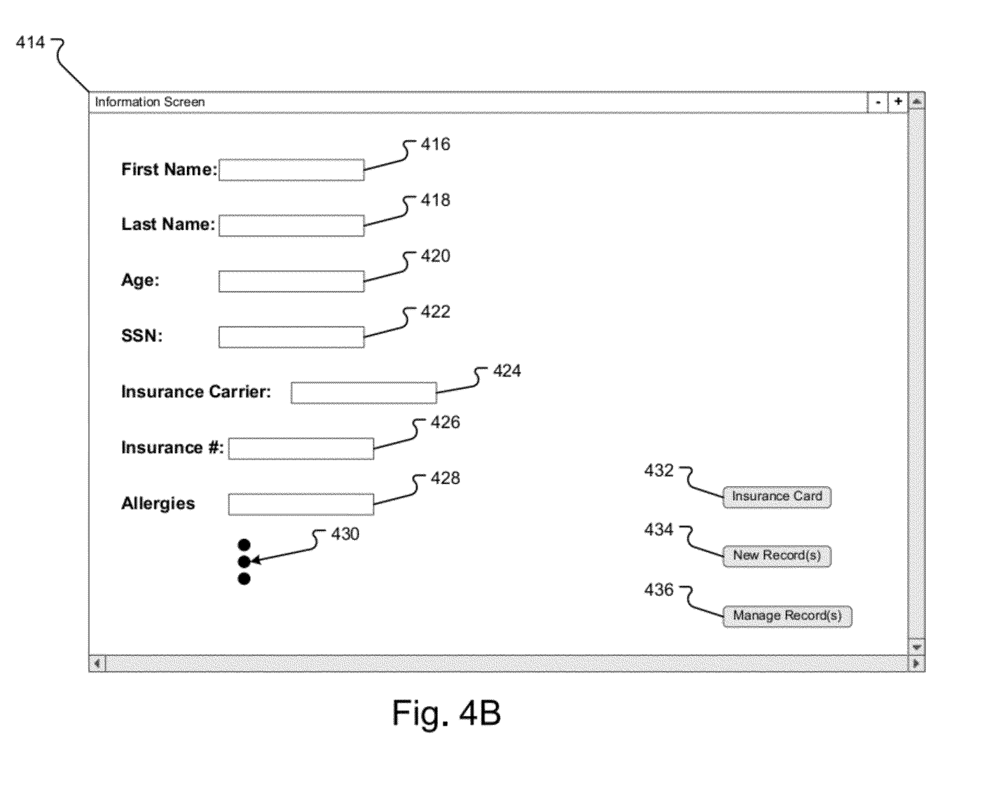

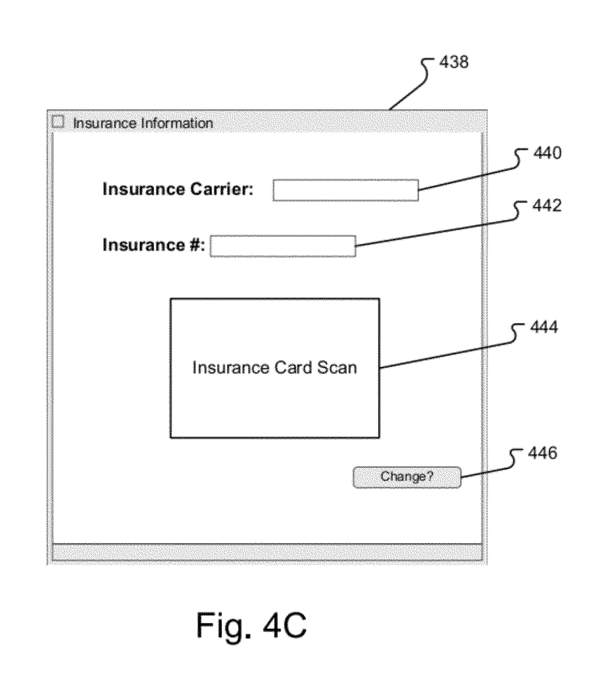

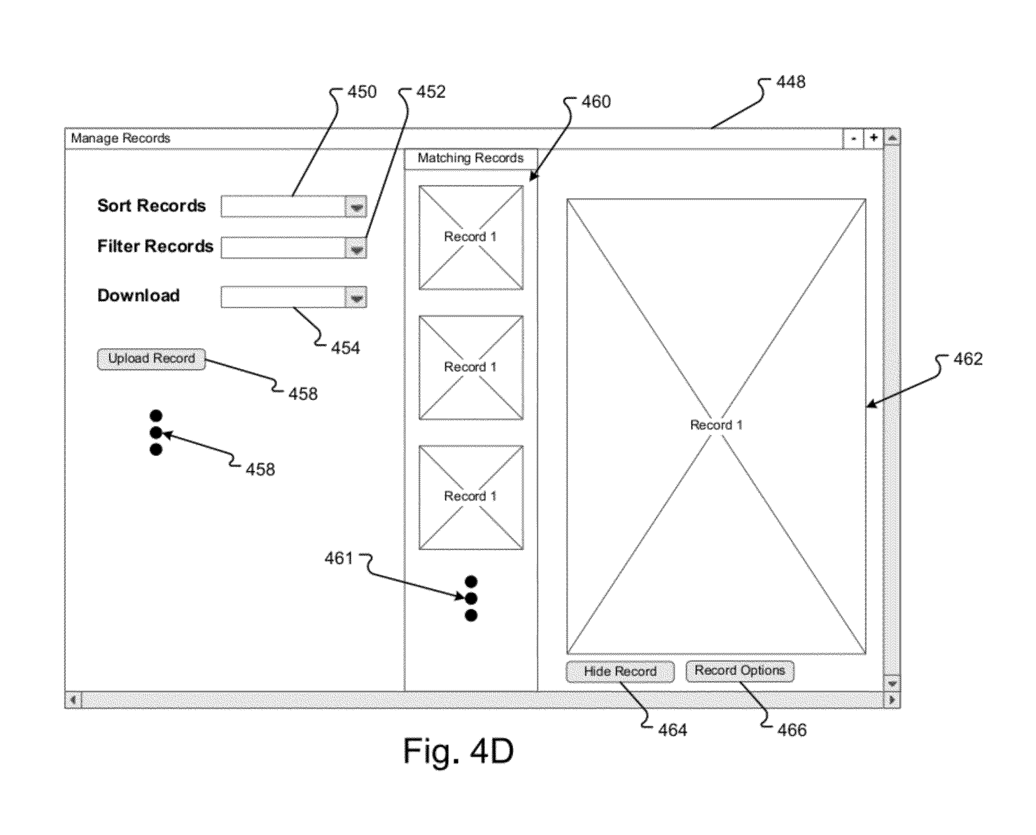

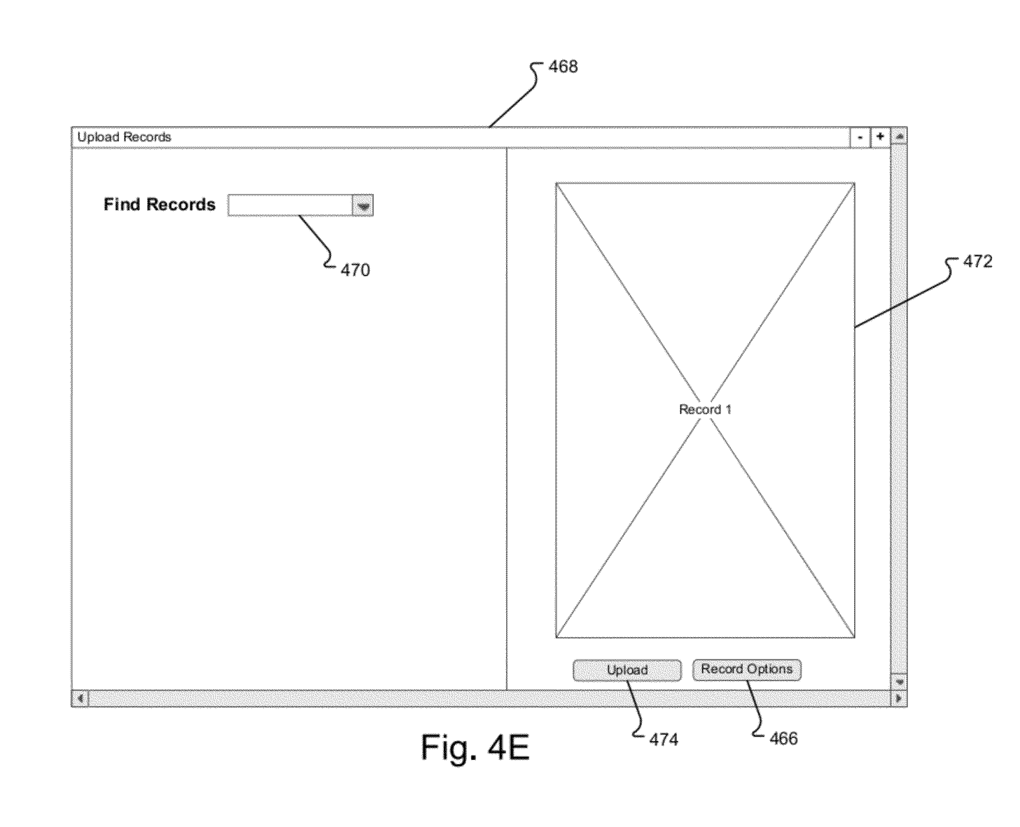

Several user interface displays are shown in FIGS. 4A through 4E. A user interface display can be a representation of information presented on a display device, such as a computer screen, a display of a mobile device or other hand held device, or other various displays as described in conjunction with FIGS. 8 and 9. The user interface display can include one or more user interface devices, which can be selected with a device, such as a mouse, a keyboard, a touch screen, or other such input/output devices, as described in conjunction with FIGS. 8 and 9. User interface devices can include buttons, radio buttons, text entry areas, pull down menus, menus, or other types of selectable elements within a user interface display. For example, a user interface device 404, shown in FIG. 4A, may be selected to eliminate or close the display 400.

The user interface can include one or more portions of a screen that may display separate information, for example, one portion of the interface device may display a window 402. Each of the user interface displays in FIGS. 4A and 4E can include information and provide various user interface devices that may be used to allow the patient or doctor to interact with the patient-centric record server 106, the patient device 102b, the patient computer 104, or the doctor's system 102c.

The user interface display 400 shown in FIG. 4A shows an initial display that allows the user to enter their username in text entry area 406 and a password in text entry area 408. After this information is entered, the user may select the user interface device 410 to enter the information to gain access to the patient-centric record server 106. The window 402 may represent a web page, thus this page may be composed of HTML code displayed on the user's computer 104. If the user is a new patient, the user may select the new patient user interface device 412 rather than enter the information. The selection of device 412 allows the user to establish an account with the patient-centric record server 106.

The user interface 414 shown in FIG. 4B may be an initial information screen that allows the patient to enter information into the patient-centric record server 106. There may be one or more text entry areas to enter information, such as the patient's first name in area 416, the patient's last name in area 418, the patient's age in area 420, the patient's social security number in area 422, the patient's insurance carrier in area 424, the patient's insurance number in area 426, and the patient's known allergies in area 428. The information entered into the information screen 414 may be more or less than what is shown in display 414, as represented by ellipses 430.

A new patient selecting user interface device 412 may be provided with display 414 to enter this information for a first time. A patient who is returning to the patient-centric record server 106 and has entered their user name and password in display 402 may be provided with the information display 414 with the information already entered. The user may change the information by re-entering the changed information.

The information screen 414 may also provide one or more other user interface devices, such as the selectable buttons 432, 434, and 436. The button 432 can provide the user the ability to enter or to change information regarding their insurance and, when selected, can cause the patient-centric record server 106 to provide the display 438 shown in FIG. 4C. If new information has been uploaded and needs to be managed, the patient display 414 may create an alert for the patient by changing the format or visual appearance of the button 434. If the new records button 434 is selected, the patient may be sent to either the manage records screen 448 in FIG. 4D or the upload screen 468 in FIG. 4E. The user may also select the manage records button 436, which causes the patient-centric record server 106 to provide display 448 in FIG. 4D.

Display 438 in FIG. 4C allows the user to enter information about the insurance carried by the patient. This information may be provided or retrieved from the database and appear in fields 440, 442, and/or 444 (similar to displays 424, 426 in the previous information screen 414). The user may select button 446 to change the information as displayed in user interface display 438. The user may then also enter the information in text area 440 and 442. Further, the user may be able to scan an insurance card into the insurance information screen, which may be presented as a display 444 in user interface 438. This insurance information may be stored with the patient-centric records 112 and/or be stored on patient device 102b to be provided to a doctor.

The user interface display 448, as shown in FIG. 4D, can be provided for the patient to manage their records. The manage records display 448 can include one or more fields that allow the patient to determine which records to manage. For example, user interface device 450 and 452 are drop down menus that allow the user to sort or filter patient records. Drop down menu 454 allows a user to download a file by selecting the file from a drop down menu 454. Button 456 allows the user to upload a record that may not have been uploaded by a doctor, and upon selecting user interface device 456, the patient may be provided with user interface display 468. There may be more or fewer user interface devices as represented by ellipses 458. Upon selecting a set of files, the files matching the criteria can be presented in screen area 460. For example, screen area 460 shows representations of three records in that portion of the user interface 460. There may be more or fewer records displayed, depending on the search criteria, as represented by ellipses 461. If the user selects one of the records in section 460, the selected record may be displayed in section 462.

Once displayed or by displaying and selecting several records, the patient may then select user interface devices 464 or 466. By selecting button 464, the patient may indicate that the selected records are to be hidden. Thus, upon selecting button 464, the patient-centric record server 106 can record the hide selection in metadata field 328 such that the record is to be hidden from view from at least one medical organization or medical professional. The sort and filter records devices 450 and 452 may allow the user to select the metadata that is shown in data structure 220 to provide one or more records associated with that metadata. Upon receiving the manage records interface 448 the user computer can send a request to manage files. The request to manage files can be a selection in one or more user interface devices 450 through 456. For example, the selection may be to sort records or filter records such that certain records with certain metadata are provided to the user. For example, the user may select all records having a visit of a certain date or time, may select records having a certain doctor type or other information that may be common among two or more records. The selection of device 466 can help record different record options that may include how the records are displayed or how the records are managed.

User interface display 468, shown in FIG. 4E, allows a patient or a doctor to upload records into the patient-centric record server 106. User interface device 470 may be a drop down menu that helps find records in an EMR system 228 or within one or more storage devices of a user computer 104. The selected files may be shown in user interface section 472, upon which the patient or doctor may select the upload button 474 to upload those files to the patient-centric record server 106. Further, the records may also be provided with record options that can be selected after selecting button 466.

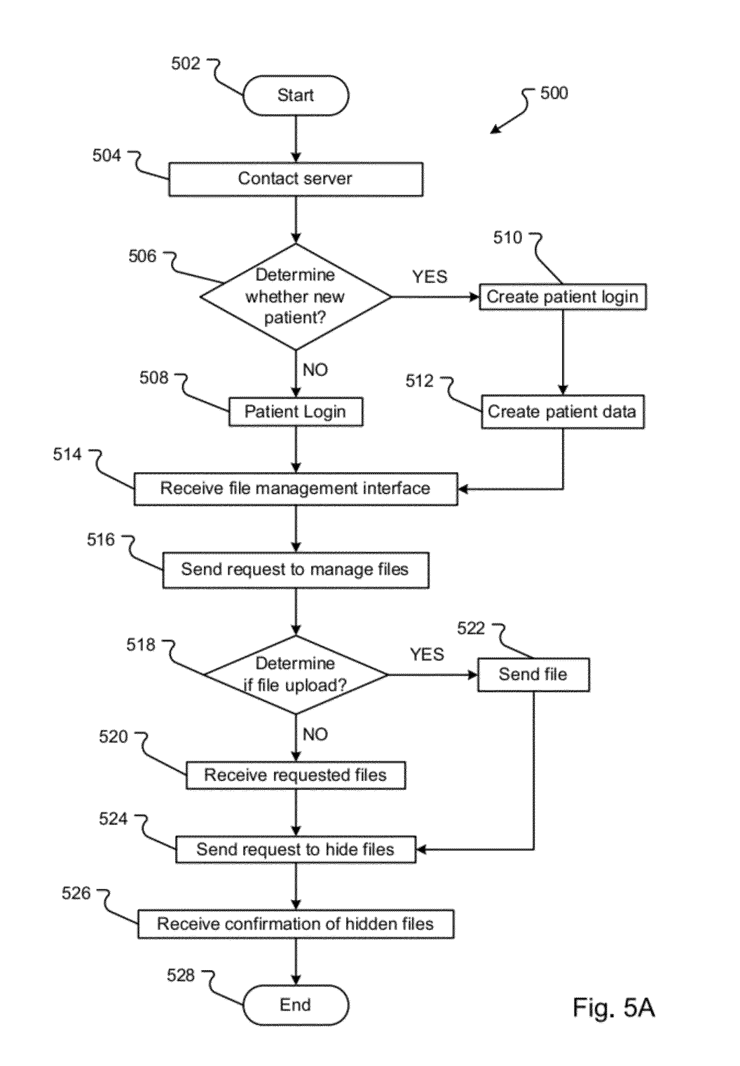

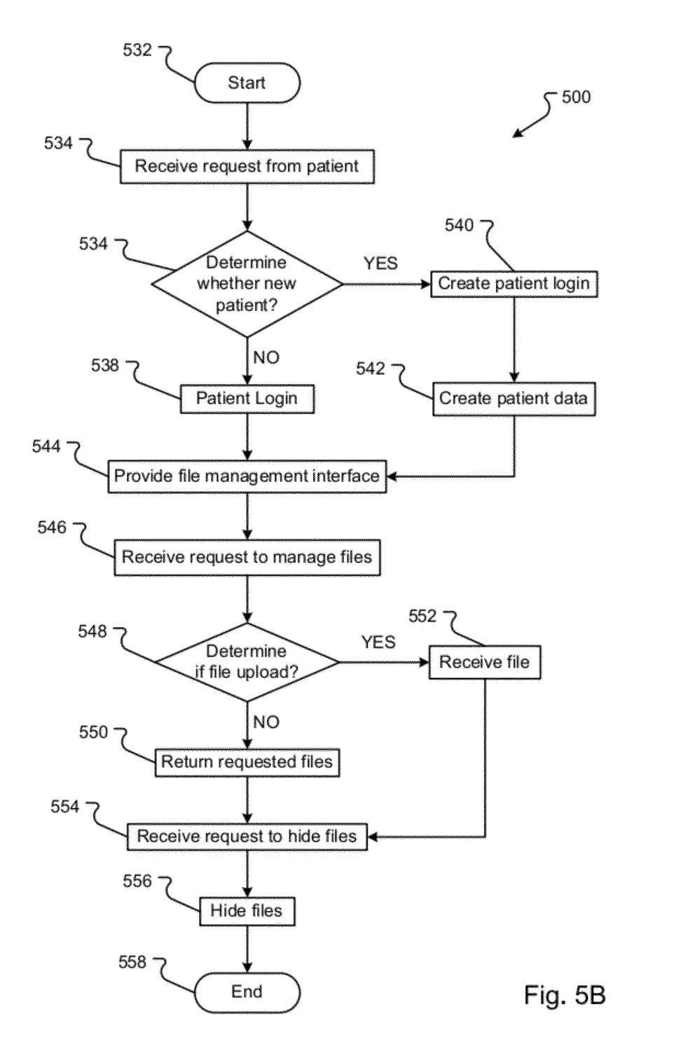

An embodiment of a method 500 for a patient managing their patient records is shown in FIGS. 5A and 5B. The method 500 is shown from the view of a patient in FIG. 5A and from the view of the patient-centric record server 106 in FIG. 5B. Generally, the method 500 begins with a start operation 502/532 and terminates with an end operation 528/558. While a general order for the steps of the method 500 are shown in FIGS. 5A and 5B, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, modules, modules, data structures, user interfaces, etc. described in conjunction with FIGS. 1-4E.

A patient using a patient computer 104 can contact the patient-centric record server 106, in step 504. The patient-centric record server 106 receives the request from the patient, in step 534. In response to receiving the request to connect with the patient-centric record server 106, the web page generator 208 generates user interface display 402 and provides the display 402 to the web service 204. The web service 204 encodes the user interface 402 and sends the display 402 through the internet interface 206 to the patient computer 104.

A determination is made whether the patient is new, in step 506. By selecting the new patient button 412 in the interface 402, the patient acknowledges that they are new to the patient-centric record server 106. The new patient signal is sent from the user computer 104 to the patient-centric record server 106 where the patient-centric record server 106 can determine whether the patient is new, in step 534. if the user selects the new patient button 412, the patient-centric record server 106 can determine that the patient is new and the method 500 flows YES to step 510/540. If the patient enters a user name and password and selects the enter button 410, the patient computer 104 can send that signal, with the user name and password included in the data packet, to the patient-centric record server 106. If the user sends the user name and password, then the patient-centric record server 106 can determine the patient is not new, and the method 500 flows NO to step 508/538.

If the patient is not new, the patient sends the user name and password from the patient computer 104 to the patient-centric record server 106, in step 508. The login information is received, by the patient-centric record server 106, in step 538, where the patient-centric record server 106 authorizes the patient to view their files. This authorization may be sent to the patient computer 104 with the initial information screen 414. If the patient is new, the patient-centric record server 106 may send the information screen 414, along with the display 402, to allow the patient to create a login, in step 540. The patient can receive the user name and password fields and enter that information to create the login, in step 510. This login information may then be sent to the patient-centric record server 106 to begin creating metadata or patient information in the patient-centric records 112.

Upon creating the initial file for the patient, the patient-centric record server 106 may send the information display 414, in step 542, to create patient data. The user computer 104 can receive the display 414 and then receive information from the patient through the user interface to create patient data, in step 512. This initial information may then be sent back to the patient-centric record server 106 to create patient information in the patient-centric records 112. Further, this information may then be stored on a patient device 102b for later use later at a doctor's office or other medical organization.

After receiving the initial information screen 414, the patient may select the button to manage records, 436, which is sent to the patient-centric record server 106. In response to receiving the manage records request, the patient-centric record server 106 can send the manage records interface 448, in step 544. The web page generator 208 can generate web page 448 and send it to the web service 204 which encodes the web page to be sent through the internet interface 206 to the user patient computer 104. This user interface 448 is received in step 514, at the patient computer 104.

The request to manage records may be sent, in step 516, to the patient-centric record server 106. The interface 206 can receive the request and send the request to the web service 204. The web service 204 can then send the request to the content engine 202 to determine what information needs to be sent back to the user computer 104. The content engine 202 can determine a request to send to the database interface 212 to retrieve patient records 218 from the patient-centric records database 112. The patient records 218 may be sent to the content engine 202. This medical information is then provided to the web service 204, which may provide the information to a web page generator 208. The information is then sent back through the internet interface 206 to the user computer 104 to be displayed in the matching records section 460 of display 448. The user may then select records, which may then be displayed in step 462, through a similar process.

The user may then select record options 466 or hide record 464, which selection may be sent from the user computer 104 back through the network 110 to the patient-centric record server 106. The selection for what to do with the files is received, in step 546, at the patient-centric record server 106. The patient-centric record server 106 then determines if it is a file upload, in step 548. If the user has selected the upload record button 456, in step 518, the method 500 proceeds YES to step 522, where the user is provided the upload display 468 to send the file, in step 522. The file may be received by the patient-centric record server, in step 552. If the file is then uploaded, the web service 204 can provide the file to the content engine 202, which may store the file through the database interface 212 into the patient records 218 stored in the patient-centric records database 112. If the action is not an upload the method 500 proceeds NO to return the requested files 550 to the user in computer 104. The requested files are then provided back to the user, which can receive the files, in step 520.

The user may then request to hide the files, in step 524. In selecting one or more files in section 460 and then selecting the hide button 464, the user sends the request to hide files to the patient-centric record server 106. The request to hide files is received, in step 554, where the web service 204 passes the hide request to the content engine 202. The content engine 202 can then enter the hide indication in the database field 328 in the record metadata 220. Thus, the patient-centric record server 106 hides the files, in step 556. A confirmation may be sent about the hidden files, such as displaying some change in the user interface display 448, and may be received by the user computer 104, in step 526.

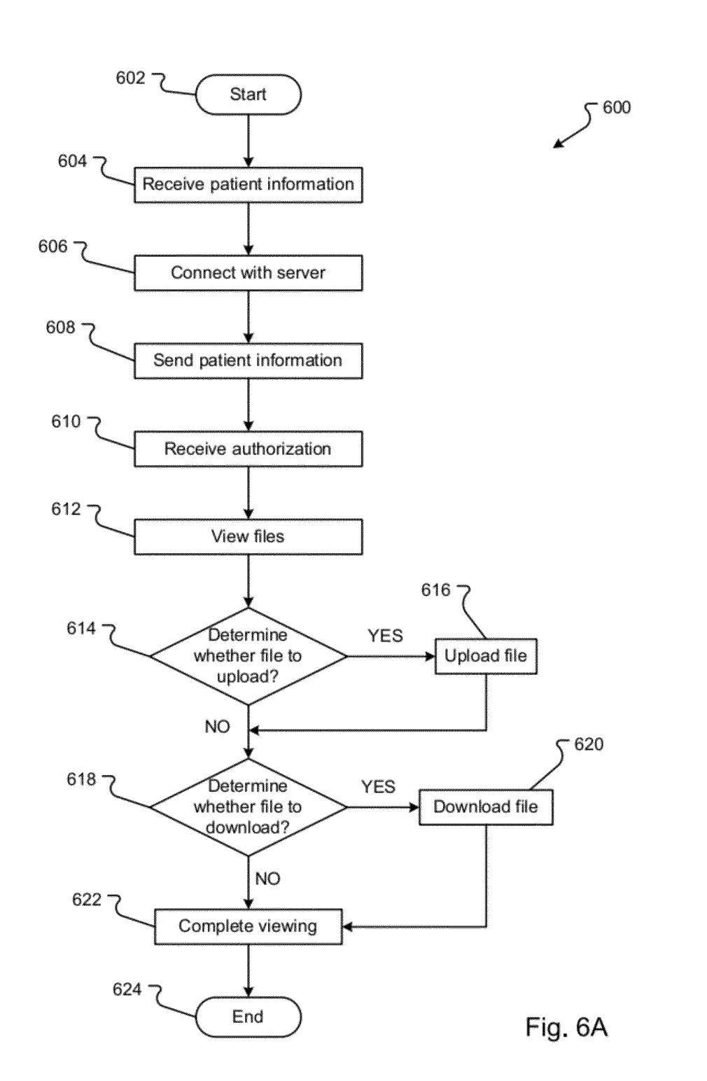

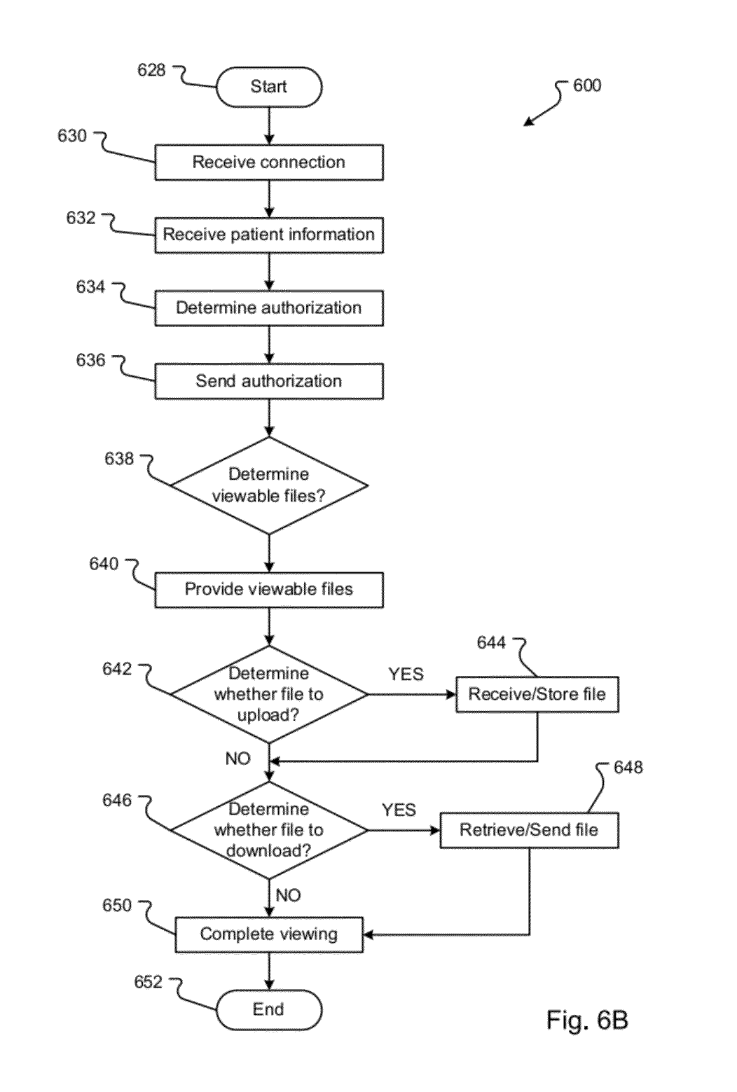

An embodiment of a method 600 for a patient managing their patient records is shown in FIGS. 6A and 6B. The method 600 is shown from the view of a patient in FIG. 6A and from the view of the patient-centric record server 106 in FIG. 6B. Generally, the method 600 begins with a start operation 602/632 and terminates with an end operation 628/668. While a general order for the steps of the method 600 are shown in FIGS. 6A and 6B, the method 600 can include more or fewer steps or arrange the order of the steps differently than those shown in FIG. 6. The method 600 can be executed as a set of computer-executable instructions executed by a computer system and encoded or stored on a computer readable medium. Hereinafter, the method 600 shall be explained with reference to the systems, modules, modules, data structures, user interfaces, etc. described in conjunction with FIGS. 1-4E.

An interface 222 of a doctors system can receive patient information from a patient device 102b, in step 604. In embodiments, the patient device 102b is a USB or other storage device, which is inserted into the interface 222 of the doctor's system 102c. Upon electrically connecting the patient device 102b with the interface 222, the user name and password or some other patient specific information is passed to the doctor system 102c. Further, the patient device 102b can transfer the patient information as entered in user interface device 414 to the doctor system 102c. Thus, the user device 102B can automatically populate information about the patient for the EMR system 228 and create a patient record 230 automatically. Once the patient specific information is received, the doctor system 102c can connect with the patient-centric record server 106 through the web interface 226, in step 606. This connection can be received by the patient-centric record server 106, in step 630. Upon establishing a virtual private network or other secure connection, the patient-centric record system interface/engine 224 can send the patient's security information through the web interface 226 to the patient-centric record server 106, in step 608. This security information may be received by the patient-centric record server 106, in step 632.

The web service 204 can pass the patient security information to a security module 210 to determine if the doctor system 102c is authorized to view patient records, in step 634. The security module 210 can compare the received patient security information to security information contained in the patient-centric records 112 to determine if the retrieved patient security information, username, password, or other information compares with the information received. If there is a favorable comparison, then the security module 210 can inform the web service 204 to authorize the doctor's system 102c by sending an authorization to view the files, in step 636. If no favorable comparison is made, and there is no authorization, the method 600 may proceed to the end operation 652. The web service 204 can send the authorization through the internet interface 206 to the doctor system 102c. The web interface 226 can receive the authorization and send the authorization to the patient-centric record system interface 224, in step 610.

Upon authorizing the doctor system 102C to receive patient records, the patient-centric record server 106 can determine what files are viewable by the doctor system 102c, in step 638. The web service 204 requests files for the doctor from content engine 202. The content engine 202 requests all files without a hide designation in the hide field 328 from the database interface 212. The database retrieves all files without the hide designation 328 and provides those viewable files to the content engine 202. The content engine 202 organizes the files and sends the files to the web service 204 to be provided through the internet interface 206 to the doctor system 102c, in step 640. These files are then received by the doctor system 102c, which sends the files to the patient-centric record system interface 224, which may translate the files into a suitable format, to be viewed through the electronic medical records system 228.

In other embodiments, a separate user interface may be provided to view the files, such that no data is transferred to the EMR system 228. The EMR system 228 can displays files and the doctor views those files, in step 612. The doctor may then treat the patient and then may want to upload a file after the end of the patient visit. Thus, the doctor system 102c determines whether there is a file upload, in step 614. If there is a file upload, the doctor system 102c may request to upload a file to the patient-centric record server 106. The web service 204 may receive the upload request and instruct the web page generator 208 to generate the user interface display 468. The web page 468 may then be sent by the web service 204 to the internet interface 206 and to the doctor system 102c. The doctor may then select one or more files to upload and then select the upload button 474 to send those files to the patient-centric record server 106.

Thus, if a file is to be uploaded, the method 600 proceeds YES to step 616 where the files are uploaded to the patient-centric record server 106. These uploaded files are received by the patient-centric record server 106, in step 644 and sent to the content engine 202 to be stored through the database interface 212 to the patient-centric record database 112. Upon uploading new records, the patient-centric record server 106 may send an alert to the information screen displayed as user interface device 434 to alert the patient the next time the patient computer 104 interfaces with the patient-centric records server 106.

The determination of whether a file is to be downloaded is made in step 618 and 646. If a doctor system 102c determines that a file is needed in the EMR system 228, a request may be sent by the patient-centric record system interface engine 224 and then on to the web service 204. The download request may require that one or more files are downloaded to the EMR system 228. If there is a file to be downloaded, the method 600 proceeds YES to step 620 and 648. If no file is to be downloaded, the method 600 proceeds NO to steps 622 and 650. If a downloaded file is requested, the web service 204 requests the file from the content engine 202, which retrieves the file through the database interface 212 from the patient records 218 in the patient record database 112, in step 648. The files are then sent to the patient-centric record system interface 224, by the web service 204, which downloads the files, in step 620. The files may then be stored by the EMR system 228 into the patient records 230.

Upon completing the download, the doctor system 102c may complete viewing or complete the interaction with the patient-centric record server 106. This completion of service may also occur if there is no file to download, in which case the patient-centric record system interface 224 may send a signal to the web service 204 to complete the viewing, in step 622 and 650. The session is then completed. It should be noted that the session may continue and that more than one patient record may be viewed during the session. At some point thereinafter, the connection between the doctor system 102c and the patient-centric record server 106 may be terminated, thus completing all viewing of all patient records.

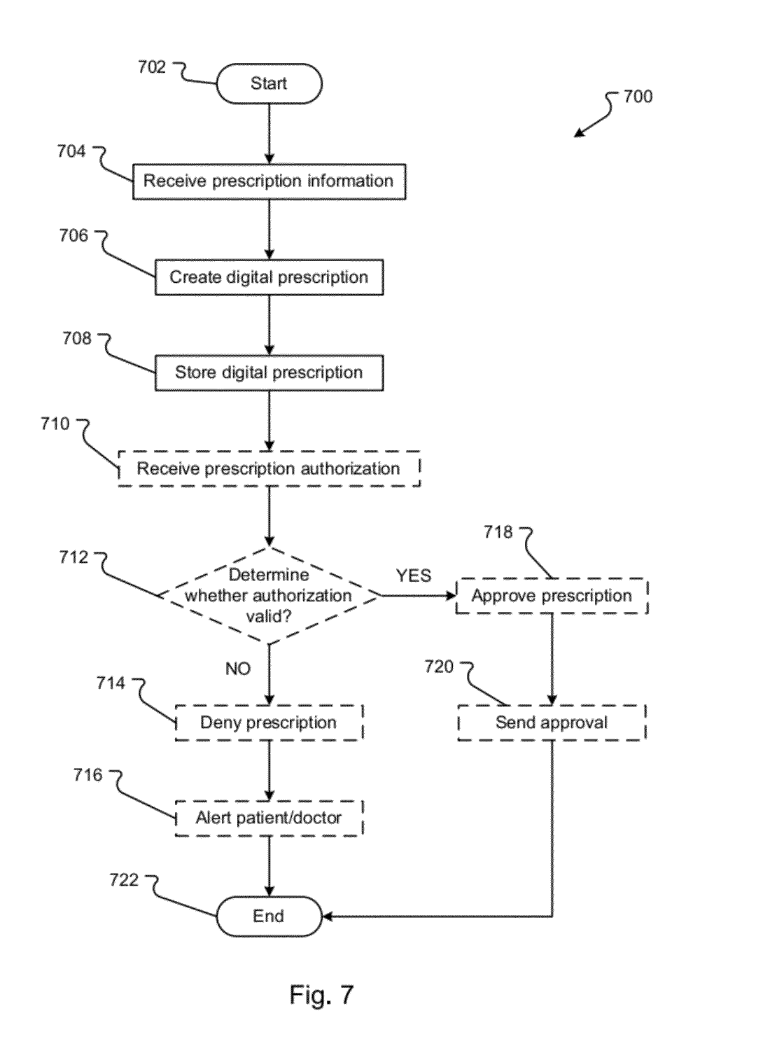

An embodiment of a method 700 for creating and providing a digital prescription for medication is shown in FIG. 7. Generally, the method 700 begins with a start operation 702 and terminates with an end operation 722. While a general order for the steps of the method 700 are shown in FIG. 7, the method 700 can include more or fewer steps or arrange the order of the steps differently than those shown in FIG. 7. The method 700 can be executed as a set of computer-executable instructions executed by a computer system and encoded or stored on a computer readable medium. Hereinafter, the method 700 shall be explained with reference to the systems, modules, modules, data structures, user interfaces, etc. described in conjunction with FIGS. 1-4E.

After treating a patient, a doctor can prescribe medication for treatment of the patient. The prescription can be entered into the doctor system 102c through the EMR system 228 or through some other user interface that communicates with the patient-centric record system interface 224. The EMR system 228 can send the prescription information to the patient-centric record system interface 224. The patient-centric record system interface 224 receives the prescription information, in step 704. The prescription information can be converted or changed in any necessary way, such that the patient-centric record system interface 224 creates a digital prescription, in step 706. The patient-centric record system interface 224 then sends the digital prescription through the interface 222 to the patient device 102b to store the digital prescription on the device 102b, in step 708.

Upon storing a digital prescription on the device 102b, the patient can then take the patient device 102b to a pharmacy to obtain the medication. The steps that follow hereinafter may be optional as the patient may be able to obtain the medication without further steps. However, in embodiments, the patient may provide the digital prescription to a pharmacy, and the pharmacy may determine if the prescription is valid. Thus the pharmacy may send a prescription authorization signal from the pharmacy to the doctor system 102c. The web interface 226 can receive the prescription authorization, in step 710.

The prescription authorization is sent to the patient-centric record system interface 224. Thereinafter, the patient-centric record system interface 224 can determine whether the prescription is valid and that the authorization is allowed, in step 712. In embodiments, a patient-centric record system interface 224 obtains or searches the list of prescriptions provided and determines if there is a matching prescription. The patient-centric record system interface 224 can request prescriptions from the EMR system 228, which can retrieve and provide the prescriptions from patient records 230. The comparison may be made by prescription number, patient name, date, medication type, and other information. In other embodiments, a code unique to the prescription is provided with the digital prescription, which may then be used to compare to prescriptions in the patient records 230. If the authorization is valid, the method 700 proceeds YES to step 718. If the authorization is not valid, the method 700 proceeds NO to step 714.

In step 718, the patient-centric record system interface 224 approves the prescription. The approval of the prescription is an authorization signal, which can be sent through the web interface 226 to the pharmacy, in step 720. This approval informs the pharmacy that the prescription is valid and to provide the medication to the patient. If the prescription is not valid, the patient-centric record system interface 224 can deny the prescription, in step 714. In denying the prescription, the patient-centric record system interface 224 can send a denial signal through the web interface 226 to the pharmacy. The pharmacy may then deny the provision of medication to the patient.

In further embodiments, the patient-centric record system interface 224 may also alert either the patient and/or the doctor that an unauthorized prescription has been made for that patient, in step 716. The alert to the doctor can provide the doctor with information that someone may have their prescription number or other data used by the doctor to prescribe medication. For the patient, the alert can alert the patient that someone is attempting to obtain medication under their identity. The patient and doctor may then respond to the possible invalid prescription in whatever means available to the patient and doctor.

FIG. 8 illustrates a block diagram of a computing environment 800 that may function as system or environment for the embodiments described herein. The system 800 includes one or more user computers 805, 810, and 815. The user computers 805, 810, and 815 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 805, 810, 815 may also have any of a variety of applications, including for example, database client and/or server applications, and web browser applications. Alternatively, the user computers 805, 810, and 815 may be any other electronic device, such as a thin-client computer, Internet-enabled mobile telephone, and/or personal digital assistant, capable of communicating via a network (e.g., the network 820 described below) and/or displaying and navigating web pages or other types of electronic documents. Although the exemplary system 800 is shown with three user computers, any number of user computers may be supported.

System 800 further includes a network 820. The network 820 can be any type of network familiar to those skilled in the art that can support data communications using any of a variety of commercially-available protocols, including, without limitation, TCP/IP, SNA, IPX, AppleTalk, and the like. Merely by way of example, the network 820 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system 800 may also include one or more server computers 825, 830. One server may be a web server 825, which may be used to process requests for web pages or other electronic documents from user computers 805, 810, and 815. The web server can be running an operating system including any of those discussed above, as well as any commercially-available server operating systems. The web server 825 can also run a variety of server applications, including HTTP servers, FTP servers, CGI servers, database servers, Java servers, and the like. In some instances, the web server 825 may publish operations available operations as one or more web services.

The system 800 may also include one or more file and or/application servers 830, which can, in addition to an operating system, include one or more applications accessible by a client running on one or more of the user computers 805, 810, 815. The server(s) 830 may be one or more general purpose computers capable of executing programs or scripts in response to the user computers 805, 810 and 815. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 830 may also include database servers, including without limitation those commercially available from Oracle, Microsoft, Sybase™, IBM™ the like, which can process requests from database clients running on a user computer 805.

The web pages created by the web application server 830 may be forwarded to a user computer 805 via a web server 825. Similarly, the web server 825 may be able to receive web page requests, web services invocations, and/or input data from a user computer 805 and can forward the web page requests and/or input data to the web application server 830. In further embodiments, the server 830 may function as a file server. Although for ease of description, FIG. 5 illustrates a separate web server 825 and file/application server 830, those skilled in the art will recognize that the functions described with respect to servers 825, 830 may be performed by a single server and/or a plurality of specialized servers, depending on implementation-specific needs and parameters. The computer systems 805, 810, and 815, file server 825 and/or application server 830 may function as servers or other systems described herein.

The system 800 may also include a database 835. The database 835 may reside in a variety of locations. By way of example, database 835 may reside on a storage medium local to (and/or resident in) one or more of the computers 805, 810, 815, 825, 830. Alternatively, it may be remote from any or all of the computers 805, 810, 815, 825, 830, and in communication (e.g., via the network 820) with one or more of these. In a particular set of embodiments, the database 835 may reside in a storage-area network (“SAN”) familiar to those skilled in the art. Similarly, any necessary files for performing the functions attributed to the computers 805, 810, 815, 825, 830 may be stored locally on the respective computer and/or remotely, as appropriate. In one set of embodiments, the database 835 may be a relational database, such as Oracle 10i™, that is adapted to store, update, and retrieve data in response to SQL-formatted commands. Database 835 may be the same or similar to the database used herein.

FIG. 9 illustrates one embodiment of a computer system 900 upon which servers or other systems described herein may be deployed or executed. The computer system 900 is shown comprising hardware elements that may be electrically coupled via a bus 955. The hardware elements may include one or more central processing units (CPUs) 905; one or more input devices 910 (e.g., a mouse, a keyboard, etc.); and one or more output devices 915 (e.g., a display device, a printer, etc.). The computer system 900 may also include one or more storage device 920. By way of example, storage device(s) 920 may be disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 925; a communications system 930 (e.g., a modem, a network card (wireless or wired), an infra-red communication device, etc.); and working memory 940, which may include RAM and ROM devices as described above. In some embodiments, the computer system 900 may also include a processing acceleration unit 935, which can include a DSP, a special-purpose processor and/or the like.

The computer-readable storage media reader 925 can further be connected to a computer-readable storage medium, together (and, optionally, in combination with storage device(s) 920) comprehensively representing remote, local, fixed, and/or removable storage devices plus storage media for temporarily and/or more permanently containing computer-readable information. The communications system 930 may permit data to be exchanged with the network 920 and/or any other computer described above with respect to the system 900. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 900 may also comprise software elements, shown as being currently located within a working memory 940, including an operating system 945 and/or other code 950, such as program code implementing the servers or devices described herein. It should be appreciated that alternate embodiments of a computer system 900 may have numerous implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the embodiments have been described in detail herein, it is to be understood that the inventive concepts may be otherwise variously embodied and employed, and that the appended claims are intended to be construed to include such variations, except as limited by the prior art.

What is claimed is:

1. A computer program product including computer executable instructions stored onto a computer readable medium which, when executed by a processor of a computer, causes the computer to perform a method for managing patient medical records, the instructions comprising:
instructions to present to a patient a medical record;
instructions to receive a signal to hide the medical record;
instructions to receive a request for the medical record from a third party; and
instructions to prevent viewing of the medical record by the third party.
